(19) United States
(12) Patent Application Publication
(10) Pub. No.: US 2009/0253212 A1
(43) Pub. Date: Oct. 8, 2009

(54) METHOD OF DETERMINING THE EFFECTIVENESS OF WATER PURIFICATION

(75) Inventors: Vyacheslav S. Gordienko, Ufa (RU); Lev I. Kantor, Ufa (RU); Lialia G. Tsypycheva, Ufa (RU); Margarita Yu. Vozhdaeva, Ufa (RU); Evgeniy A. Kantor, Ufa (RU); Igor A. Melnitskiy, Ufa (RU); Natalya V. Trukhanova, Ufa (RU)

Correspondence Address: HOUSTON ELISEEVA, 4 MILITIA DRIVE, SUITE 4, LEXINGTON, MA, 02421, US

(73) Assignee: MUP "UFAVODOKANAL", Ufa (RU)

(21) Appl. No.: 12/058,283

(22) Filed: Mar. 28, 2008

(30) Foreign Application Priority Data
Mar. 29, 2007 (RU) 2007111624

(51) Int. Cl. G01N 30/00

(52) U.S. Cl. 436/146

(57) ABSTRACT

Prospective invention concerns to area of ecology and analytical chemistry, and also to water treatment, and can be used for estimation the effectiveness of water purification from different origin on water intakes with various stages of technological processing, for assessment of overall performance of filters and water treating devices of household and industrial purpose. The essence of technique consists in use of generalized parameter of total carbon content—technogenic organic carbon—in semi-volatile organic compounds before and after stages of water treatment. The total carbon content is determined by gas chromatography coupled with atomic-emission detection. Due to high sensitivity of method, parameter technogenic organic carbon correctly reflects changes of water quality during water treatment.

### RELATED APPLICATIONS

This application claims priority to Russian Patent Application No. 2007111624, filed on Mar. 29, 2007, which is incorporated herein by reference in its entirety.

### FIELD OF THE INVENTION

The invention concerns to ecology and analytical chemistry, and also to water treatment, in particular to a method of water treatment efficiency definition which can be applied on water supply facility with various stages of the technological processing, using river water, well water and other types of water, sources for evaluation efficiency of filters and other treating devices of drinking and industrial water.

### BACKGROUND OF THE INVENTION

Effectiveness of water purification as a whole and at its separate stages is assessed by contents of controllable substances in water before and after an investigated stage of treatment. Traditional stages reagent treatment, such as processes of clarification (filtration, coagulation), oxidations (ultra-violet disinfecting, chlorination, ozonization), sorbtion (treating by powdered activated carbon, etc.), membrane methods, are applied during water purification. The effectiveness assessing of each stage water treatment is necessary for selection of the optimum water treatment technology, in this case from semivolatile organic compounds. Most of technogenic substances such as pesticides, petrochemical and chemical production, oxidative destruction products of natural high-molecular organic compounds, algae metabolites and other toxic contaminants and their derivatives as well enter in this group. Checking of all controlled compounds in water to select optimal conditions of the purification is time-consuming, demands numerous of the certificated techniques and various instrument park. On the other hand, such approach assessing of water treatment technologies efficiency is not expedient, as will be never sufficiently informative, and the list contaminations obligatory for the control never could involve all compounds present in water and affect on its final quality. The set and composition of such compounds frequently changeable and also depends on many factors, including climatic and seasonal conditions, proximity of industrial objects, composition of natural organic compounds in source water, causing formation of various classes by-products at reagent treatment (for example, formation brom-, chlor-, oxygen-containing organic compounds during the chlorination of water in result of destruction natural humic and fulvic acids). In such situation more logical appears the approach based on valuation of total organic impurities in water for a choice of effective technology of water treatment before and after stage of purification.

Widespread integral parameters of water quality are chemical oxygen demand (COD), permanganate index, total organic carbon (TOC).

It is known the mode of estimation COD (International standard ISO 6060 <<Method determination of COD in water>>). The COD expresses the amount of oxygen originating from potassium dichromate that reacts with the oxidizable substances. Sensitivity of method is 4 mgO/dm3.

It is known the mode of estimation permanganate index (PIndex) (International standard ISO 8467 <<Method determination of permanganate index in water>>) which is based on oxidation of sample components by potassium permanganate by boiling in acid medium. Sensitivity of method is 0.25 mgO/dm3.

It is known the mode of estimation total organic carbon (TOC), based on oxidation of carbon in water organic components by potassium persulfate with UV irradiation with the further photometric determination (TOCUV) or thermocatalytic oxidation (TOCTKat) to carbon dioxide which concentration is evaluated by chromatography after conversion of carbon dioxide to metane (International standard ISO 8245 <<Manual by determination of total organic carbon>>). Method response limit—1 mg/dm3.

The listed integral parameters estimate total contents of organic compounds in water, including natural and technogenic impurities, and some of them include an assessment of contents inorganic substances. At the same time, the contribution of natural organic compounds (humic substances) multiple exceeds contribution of technogenic impurities. Therefore, by means of these indicators (TOC, COD, PIndex) it is possible to estimate effectiveness of water treatment basically from natural compounds. Moreover, the contents of natural organic substances can decrease during water purification due to formation toxic chlor-, brom- or oxigencontaning by-products at disinfection stage which being volatile and semi-volatile compounds with smaller molecular weight, lower boiling temperatures and different oxidability. Thus, the listed integral parameters allow to estimate decrease of only natural organic compounds during water treatment, do not reflect change of water impurity under semi-volatile organic compounds (SVOC), presented in water up to and formed during water treatment, because of low sensitivity of methods of integral parameters determination, and consequently may be incorrectly estimate effectiveness of investigated technology in whole.

Technogenic organic impurity like pesticides, aromatic and aliphatic hydrocarbons, fat acids, ethers, phenols, polyaromatic hydrocarbons and other ecotoxicants and their derivatives make the basic pant of SVOS possessing high toxicity of water and having low values of maximum concentration level (MCL) in water. Chromatographic methods with various kinds of detecting allow to evaluate efficiency of removal SVOS during water treatment. However, in this case the evaluation of contents of all individual SVOS in water before and after water treatment demands numerous of the techniques, specific detective devices, presence of standards of each determined components of sample, and is the extremely labour-consuming.

Thus, in the literature method to evaluate summary efficiency removal of SVOS with use of any integral parameters during water treatment is not described.

### DETAILED DESCRIPTION OF THE PREFERRED EMBODIMENTS

The suggested method differs that allows to evaluate quantitatively the common impurity of water SVOS before and after treatment by the total contents of carbon in this compounds with the help of a method of a gas chromatography with atomic-emission detecting (GC-AED).

The offered method is based on an opportunity of estimate of the total carbon content in compounds with boiling temperature 150-500° C., eluated from chromatographic columns for one detection, with one-two standard substances at the analysis on wave length of carbon by means of AED. Quantitative detection of carbon total contents is possible probably due to a combination of some properties of AED, including independence of its response from determined component structure [Janak K., Colmsjo A., Ostman C. The quantitative analysis with using of a gas chromatography with atomic-emission detection//J. Chromatogr. Sci. 1995. V. 33. P. 611-620]. Sensitivity of carbon detection by work on wave length 193 nm is equal 1×10⁻⁵ mg/dm³, that some orders is higher than detection sensitivity of other known integral parameters. As basic part SVOS is made by compounds of the technogenic nature, the used index of the total carbon content in them is named technogenic organic carbon (TgOC).

Definition TgOC is carried out as follows:

Extractive recovery of organic impurities are carried out from a water sample of the fixed volume before stage of clearing and a water sample of the same volume after stage of clearing. Extract is evaporated up to necessary concentration and analyzed by GC-AED method on length of carbon emission. Total area of all peaks is measured on carbon elementselective chromatogram, TgOC concentration is calculated with method of external standard.

Distinctive attribute of this method is absence of necessity precise chromatographic fractionation of components, their identification and presence of standard samples of all determined components. Meanwhile quantitative estimation TgOC is carried out with the sensitivity repeatedly exceeding sensitivity of definition of traditional integral parameters and adequately reacts to insignificant pollution of water by organic compounds technogenic origins.

### EXAMPLE 1

A number of technogenic compounds (pesticides, chlorophenols and hydrocarbons of petroleum diesel fraction), which were absent in initial water, was added in river water (r. Ufa). Spiked water samples were extracted with methylene chloride, an extract was evaporated up to a degree of concentrating 1:10000 and analyzed by GC-AED method on a wave length of carbon 193 nm at programming column temperature from 35 to 60° C. with speed of 20 degree/min and further to 280° C. with a speed of 6 degree/min. Settlement data on carbon contents in water at the yielded artificial pollution are resulted in table 1. Results of water analysis before and after pollution minus contribution of used solvents are resulted in table 2. Concentration of entered substances relative to their maximum concentration level were significant, but have not affected on value of the chemical oxygen demand, permanganate index and TOC, and value of parameter technogenic organic carbon appeared to be close to the spiked amount of carbon. Thus it is appeared possible to estimate impurity of water by technogenic contaminants with use of parameter technogenic organic carbon.

### EXAMPLE 2

Research of Ufa river water before and after artificial contamination by petroleum products and further clearing this water by reagent treatment and sorbtion at the activated carbon is carried out on procedure of preparation of samples and the analysis, described in an example 1. Pilot plant included module for input of simulating solution of artificial contaminations to water (therein—petroleum products), module for mixture of reagents (aluminium sulfate and polyacrylamide), module of water clarification and module of filtering including a filtration column, loaded fractionated fine-grained burnt rock. Contaminated water with added powdered activated carbon feeded to module for mixture with reagents and further on clarification and filtering. Results of the general water pollution determination with the help of the parameter technogenic organic carbon before and after treatment are resulted in table 3.

TABLE 3
Technogenic organic carbon before artificial contamination
of water sample with petroleum products and after treating

| | Concentration in sample, mg/dm³ | | |
|---|---|---|---|
| | No 1^{a} | No 2^{b} | No 3^{c} |
| Technogenic organic carbon | 0.0043 | 0.042 | 0.0084 |
| (TgOC) | | | |

^{a}initial sample of water of the Ufa river;
^{b}sample of water of the Ufa river, contaminated with petroleum products;
^{c}sample of water of the Ufa river, contaminated with petroleum products after treatment

Efficiency of the water treatment has reached 80%. on the index TgOC. Presence of petroleum products in tests by other methods was not fixed, in particular by IR-spectrometer method (GOST R 51797-2001 <<Method of determination of petroleum products>>, minimally determined concentration of petroleum products—0.05 mg/dm3).

### EXAMPLE 3

Research of water of the Ufa river before and after artificial contamination by petroleum products, clearing and treating by chlorine water is carried out on procedure of preparation of samples and the analysis, described in an example 1. Concentration of additive (diesel fraction of petroleum) made 0.26 mg/dm³ (2,6 maximum concentration level for petroleum products). Treatment of the contaminated water was carried out by introduction powdered activated coal with the subsequent reagent processing, clarification and filtering through fine-grained burnt rock. At the following stage batching of the chlorine water was carried out. Results of the determination of general water pollution before and after listed stages of the treatment with use of the parameter TgOC are resulted in table 4.

TABLE 4
Values of the generalized indexes before pollution of the water
sample by petroleum products and after its purification

| | | Concentration in sample, mg/dm³ | | | |
|---|---|---|---|---|---|
| N | Parameters | No 1^{a} | No 2^{b} | No 3^{c} | No 4^{d} |
| 1 | TOC_{TKat} | 6.55 | 6.63 | 6.08 | 5.24 |
| 2 | TOC_{UV} | 3.6 | 3.2 | 2.9 | 2.4 |
| 3 | Permanganate index, | 3.4 | 3.1 | 1.9 | 1.5 |
| | MrO/dm³ | | | | |
| 4 | Petroleum products* | <0.05 | 0.191 | <0.05 | <0.05 |
| 5 | Technogenic organic | 0.0107 | 0.231 | 0.0069 | 0.0127 |
| | carbon (TgOC) | | | | |

*total contents of petroleum products, determined IR-spectrometric method (GOST R 51797-2001 <<Method determination contents of petroleum products>>, minimally determined concentration of petroleum products - 0.05 mg/dm3)
^{a}initial sample of water of the Ufa river;
^{b}sample of water of the Ufa river, contaminated by petroleum products;
^{c}sample of water of the Ufa river, contaminated by petroleum products after treatment (introduction powdered activated coal, reagent processing, clarification and filtering);
^{d}sample of water of the Ufa river, contaminated by petroleum products after treatment and further chlorination

Efficiency of the water treatment has reached 97% on index TgOC in this experiment with application of the described water treatment technology.

Chlorination carrying out has increased the general carbon contents in semi-volatile organic compounds according to index TgOC twice. The last specifies in passing of oxidation decomposition of natural high-molecular organic compounds to compounds with smaller molecular weight that affects the quality of the water.

Use of such generalized parameters as TOC (TOC_{Tkat}, TOC_{UV}), permanganate index in given example not informatively because of the significant contents of natural high-molecular compounds in water that does not allow to differentially evaluate presence petroleum products as apart of contaminations and to estimate water treatment influence. Application of the IR-spectrometry method in the analysis also not informatively enough as does not enable to estimate a degree of water clearing from petroleum products because of method low sensitivity. At detection of technogenic organic carbon, high-molecular compounds are not extracted by methylen chloride from water and are not chromatographed under given conditions of the analysis.

Thus, parameter technogenic organic carbon allow to estimate both efficiency of water treatment from technogenic impurities at different stages of water purification, and change of water quality in whole.

### EXAMPLE 4

Data by assessment efficiency of water treatment by household filter, installations of water deionisation and distillation are listed in table 5.

Efficiency of the water treatment with use of household filter, where activated carbon was used as a sorbent, achieves 90% on parameter TgOC.

Efficiency of the water treatment with help deionisation installation, where water with initially low contents of organic substances was fed, has made 65% on parameter TOCᵤᵥ. At the same time reverse picture was observed on parameter technogenic organic carbon—quality of water after installation was worse, than up to it (table 5). Received data specify sufficiently high efficiency of membranous filters in relation to high-molecular compounds, and on capability of accumulation SVOS on filtering elements that leads to gradual desorbtion of these connections in prepared water.

The evaluation of the water treatment efficiency from organic compounds at distillation use has shown, that the degree of purification from high-molecular compounds has made about 60%. Abundances SVOS, as well as in a case deterioration installation, deterioration of water is observed (table 5).

Thus, suggested generalized parameter TgOC is sensitive and informative for an express estimation of water treatment efficiency from SVOS during water purification on water supply facility with various stages of technological processing, at use of filters and devices of water treatment of a household purpose.

While this invention has been particularly shown and described with references to preferred embodiments thereof, it will be understood by those skilled in the art that various changes in form and details may be made therein without departing from the scope of the invention encompassed by the appended claims.

TABLE 1
The maintenance of contaminants in analyzed samples

| | Concentration in water, mg/dm³ | | | | | | | |
|---|---|---|---|---|---|---|---|---|
| Entered spiked | Experience 1 | | Experience 2 | | Experience 3 | | Experience 4 | |
| contaminations | Substances | Carbon | Substances | Carbon | Substances | Carbon | Substances | Carbon |
| Hexachlorobenzene | — | — | 0.0005 | 0.00013 | — | — | — | — |
| α-Hexachlorocyclohexane | — | — | 0.001 | 0.00025 | — | — | — | — |
| β-Hexachlorocyclohexane | — | — | 0.001 | 0.00025 | — | — | — | — |
| γ-Hexachlorocyclohexane | 0.002 | 0.00049 | 0.001 | 0.00025 | — | — | — | — |
| Metaphos (Methylparathione) | 0.002 | 0.00073 | 0.001 | 0.00036 | — | — | — | — |
| DDE | — | — | 0.001 | 0.00053 | — | — | — | — |
| DDT | 0.001 | 0.000486 | 0.002 | 0.00097 | — | — | — | — |
| Karate (Cyhalothrin) | 0.004 | 0.0024 | 0.003 | 0.0018 | — | — | — | — |
| Ambush (Permethrine) | 0.007 | 0.0045 | 0.01 | 0.0064 | — | — | — | — |
| Decis (Deltamethrine) | 0.006 | 0.00313 | 0.003 | 0.0016 | — | — | — | — |
| Simazin (Aquazine) | 0.002 | 0.00083 | 0.001 | 0.00042 | — | — | — | — |
| Atrazin (Gesaprim) | 0.002 | 0.00089 | 0.001 | 0.00045 | — | — | — | — |
| Benzo(a)pyrene | 0.00005 | 0.00005 | — | — | — | — | — | — |
| Phenol, 2,4-dichloro- | 0.002 | 0.00088 | 0.0012 | 0.00053 | — | — | 0.01 | 0.0044 |
| Phenol, 2,4,6-trichloro- | 0.002 | 0.00073 | 0.002 | 0.00073 | — | — | — | — |
| Phenol, pentachloro- | — | — | 0.01 | 0.0027 | — | — | — | — |
| Oil parafines C₁₁-C₂₇ | — | — | — | — | 0.03 | 0.025 | — | — |
| Total | | 0.01511 | | 0.01737 | | 0.025 | | 0.0044 |

TABLE 2
Change of the generalized parameters of the water quality at artificial pollution

| It is entered spiked amount | | The generalized parameters | | | | |
|---|---|---|---|---|---|---|
| | Added | | | | TgOC | |
| | concentration³⁾, | PIndex | COD | TOC_{UV} | The found | ΔC⁵⁾, |
| Substance | mg/dm³ | mgO/dm³ | mgO/dm³ | mg/dm³ | concentration⁴⁾, mg/dm³ | mg/dm³ |
| Initial water | — | 1.8 | 8.1 | 2.50 | 0.0205 | — |
| Pesticides¹⁾ | 0.0151 | 1.7 | 8.0 | 2.48 | 0.0329 | 0.0124 |
| Pesticides and phenols²⁾ | 0.0173 | 1.9 | 8.2 | 2.52 | 0.0356 | 0.0151 |
| Oil hydrocarbons | 0.0250 | 1.8 | 7.9 | 2.40 | 0.0372 | 0.0167 |
| (C₁₁-C₂₇) | | | | | | |
| Phenols | 0.0044 | 1.9 | 8.1 | 2.49 | 0.0255 | 0.0050 |

¹⁾12 components with concentration 0.5-4 maximum concentration level;
²⁾14 components with concentration 0.5-3 maximum concentration level;
³⁾of added substances in recalculation on the carbon, spiked in initial water;
⁴⁾Concentration of carbon found in initial water and in samples after the additive of substances;
⁵⁾ΔC - a difference between the found concentration (4) in tests with the additive and added concentration (3) in initial water; the size ΔC should correspond added concentration.

TABLE 5
Contents of technogenic organic carbon in
water after various kinds of treatment

| | Technogenic organic carbon | TOC_{UV}, |
|---|---|---|
| Samples of water | TgOC, mg/dm³ | mg/dm³ |
| Water before the household filter | 0.0058 | |
| Water after the household filter | 0.0006 | |
| Water before installation of | 0.0098 | 1.7 |
| deionization of water | | |
| Water after installation of | 0.016 | 0.6 |
| deionization of water | | |
| The water submitted to a distiller | 0.0012 | 1.7 |
| Water after distiller | 0.058 | 0.7 |

What is claimed is:

1. A method of determining effectiveness of water purification comprising the steps of:
(a) providing a sample of non-purified water;
(b) performing gas chromatographic atomic emission detection for a value of total organic carbon on the sample of non-purified water;
(c) providing a sample of purified water;
(d) performing gas chromatographic atomic emission detection for a value of total organic carbon on the sample of purified water; and
(e) comparing the values of total organic carbon attained in steps (b) and (d);
wherein the effectiveness of water purification is determined from a total amount of partially-fugitive organic compounds, the latter being resolved from the result of comparing in step (e).
